(19) United States
(12) Patent Application Publication
(10) Pub. No.: US 2003/0009489 A1
(43) Pub. Date: Jan. 9, 2003

(54) Method for mining data and automatically associating source locations

(76) Inventor: Steven K. Griffin, Oklahoma City, OK (US)

Correspondence Address: Crowe & Dunlevy, 1800 Mid-America Tower, 20 North Broadway, Oklahoma City, OK, 73102-8273, US

(21) Appl. No.: 10/159,731

(22) Filed: May 29, 2002

Related U.S. Application Data
(60) Provisional application No. 60/294,415, filed on May 29, 2001.

(51) Int. Cl. G06F 15/00

(52) U.S. Cl. 707/500

(57) ABSTRACT

The present invention provides a method and software for organizing data selected from electronic documents by automatically associating citation information to the selected data. In one embodiment, the source location, such as the URL, is associated with the selected data to reference the source for the data. In another embodiment, desired data is selected from an electronic document, data and citation attributes are collected for the selected data and automatically associated.

### RELATED APPLICATION

This application claims priority to Provisional Patent Application No. 60/294,415 filed May 29, 2001.

### FIELD OF THE INVENTION

The present invention relates to computer software and more particularly, but not by way of limitation, to computer software for appending a URL address to data collected from an electronic document stored on a global computer network, such as the Internet.

### BACKGROUND OF THE INVENTION

The information available on the Internet continues to grow at an astounding rate. Search engines are becoming more and more sophisticated at finding and retrieving information of interest; however, even the most sophisticated search engine retrieves a large amount of extraneous information. Users currently have no efficient tool for filtering, saving and organizing the information retrieved by such search engines. Most users will save and organize the information in one of a limited number of ways. One familiar way of organizing such information is to add the URL address to a QuickList of preferred URL addresses, often referred to as a “favorites” list. Although this is helpful, it suffers obvious drawbacks. For example, using this method a user cannot assemble only information of interest from a web site. Rather, each URL address is a link to all of the information stored at a web site. Each “favorites” list is merely a collection of links to web sites of interest, with no way to filter the information contained at a particular site.

Another method of assembling information is to print the entire web page to save a hard copy of the page displaying the information of interest. The printed pages can then be read and manually highlighted or underlined by the user. Normally, the URL will be printed at the bottom of the page so that the user will have the address for the web site of interest. This allows the user to return to the page at a later time, if desired. This method also suffers a significant drawback, however, in that the data retrieved is stored in hard copy, not electronically.

Yet another method of collecting information retrieved from the Internet is to highlight the text of interest, electronically copy the information to the clipboard and then paste the information from the clipboard into a word processing program. If the user desires to associate the URL address for the web site where the information was stored, he must do so manually. This is typically accomplished by either typing the URL information into the word processing program or by copying the URL address from the address field of the web browser to the clipboard and then pasting it into the word processor. This method is very inefficient, requiring the user to make multiple cut and paste operations and switch between at least two separate applications. Thus, there exists a need for a method and software for filtering, saving and organizing web content retrieved from the Internet or another source of electronic information.

### SUMMARY OF THE INVENTION

The present invention provides a method and software for organizing data selected from electronic documents by automatically associating citation information to the selected data. In one embodiment, the source location, such as the URL, is associated with the selected data to reference the source for the data. In another embodiment, desired data is selected from an electronic document, data and citation attributes are collected for the selected data and automatically associated.

### DESCRIPTION OF THE DRAWINGS

FIG. 1 is a general block diagram of a computer system that serves as an operating environment for the present invention.

FIG. 2 is a diagram illustrative of a client/server architecture in accordance with a preferred embodiment of the present invention.

FIG. 3 illustrates a detailed block diagram of a client/server architecture in accordance with a preferred embodiment of the present invention.

FIG. 4 illustrates an example embodiment of how the data miner uses a browser control to retrieve and display HTML documents.

FIGS. 5A and 5B is a flow diagram illustrating a preferred embodiment of the present invention.

### DETAILED DESCRIPTION OF THE PREFERRED EMBODIMENT

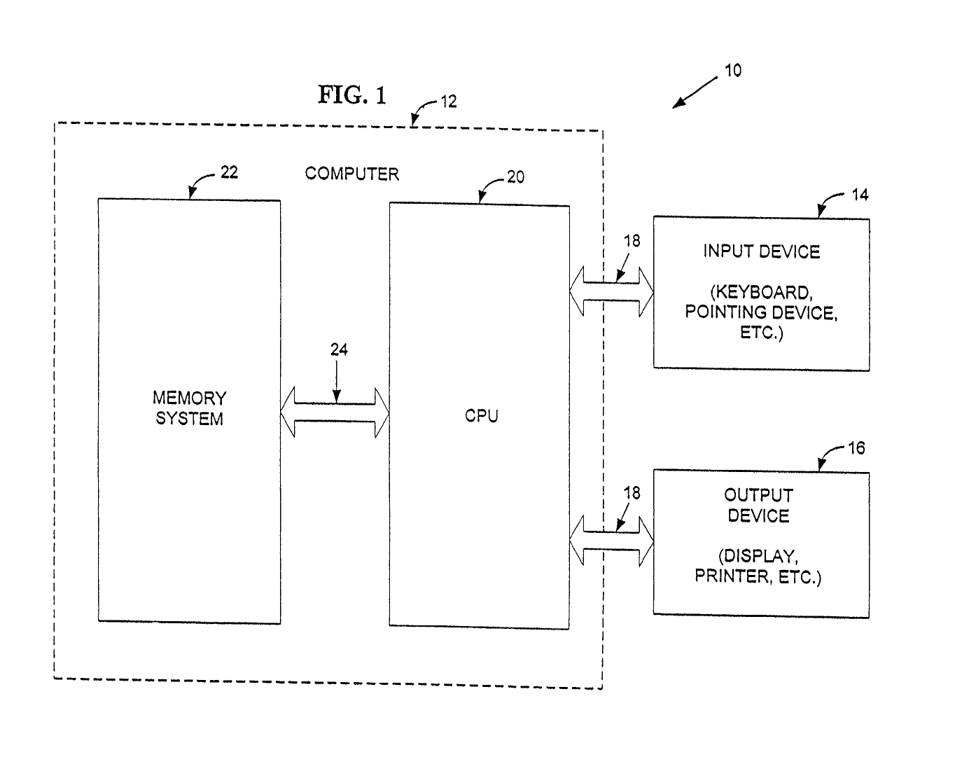

With reference now to the figures and in particular with reference to FIG. 1, there is depicted a general block diagram of a computer system that serves as an operating environment for a web browser control and the data mining software of the present invention. The computer system 10 includes as its basic elements a computer 12, one or more input device 14 and one or more output device 16. Input and output devices 14 and 16 are typically peripheral devices connected by bus structure 18 to computer 12. Input device 14 may be a keyboard, mouse, or other device for providing input data to the computer. The output device 16 represents a display device for displaying images on a display screen as well as a display controller for controlling the display device. In addition to the display device, the output device may also include a printer, sound device or other device for providing output data from the computer. Some peripherals such as modems and network adapters are both input and output devices, and therefore, incorporate both elements 14 and 16 in FIG. 1.

Computer 12 is constructed with a conventional system architecture and includes a central processing unit (“CPU”) 20 and a memory system 22, which communicate through a bus structure 24. Although not separately designated, it is conventional for the CPU 20 to include an arithmetic logic unit (ALU) for performing computations, registers for temporary storage of data and instructions and a control unit for controlling the operation of computer system in response to instructions from a computer program such as an operating system or an application program. The computer can be implemented using any of a variety of known architectures and processors such as those manufactured by Intel, IBM, Motorola, Cyrix, AMD, and Nexgen.

Memory system 22 generally includes high speed main memory (not separately designated) that is implemented using conventional memory media such as random access memory (“RAM”) and read only memory (“ROM”) semiconductor devices. Memory system 22 generally also includes secondary storage (not separately designated) that is implemented in media such as floppy disks, hard disks, tape, CD ROM, etc. The main memory stores programs such as the operating system and any application programs that are open and running. The operating system is the set of software which controls the computer system's operation and the allocation of resources. The application programs are the set of software that performs a task desired by the user, making use of computer resources made available through the operating system. In addition to storing executable software and data, portions of main memory may also be used as a frame buffer for storing digital image data displayed on a display device connected to the computer 12.

It should be understood that FIG. 1 is a block diagram illustrating the basic elements of a computer system; the figure is not intended to illustrate a specific architecture for a computer system 10. For example, no particular bus structure is shown because various bus structures known in the field of computer design may be used to interconnect the elements of the computer system in a number of ways, as desired. CPU 20 may be comprised of a discrete ALU, registers and control unit or may be a single device in which one or more of these parts of the CPU are integrated together, such as in a microprocessor. Moreover, the number and arrangement of the elements of the computer system may be varied from what is shown and described in ways known in the computer industry.

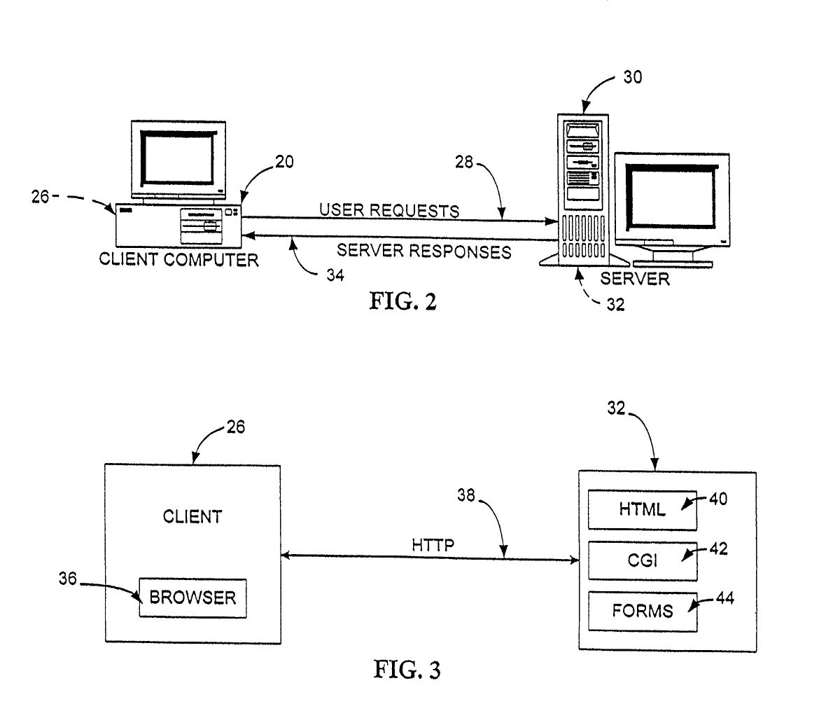

Turning now to FIG. 2, shown therein is a diagram illustrative of a client/server architecture in accordance with a preferred embodiment of the present invention. In FIG. 2, the client computer 20 has client application programs 26 resident in the memory system (not shown in FIG. 2). Client application programs 26, such as network browsers, are the typical means of accessing data stored on remote computer systems. The client application programs 26 accept commands from the user and obtain data and services by sending user requests 28 to a server 30 having server software 32.

The server 30 can be a remote computer system accessible over the Internet or other communication network. Server 30 performs scanning and searching of raw (e.g., unprocessed) information sources (e.g., electronic documents) and, based upon these user requests, presents the filtered electronic information as server responses 34 to the client computer 20. The client computer 20 communicates with the server 30 over a communications medium. In this manner, multiple clients can take advantage of the information-gathering capabilities of the server 30, thus providing distributed functionality.

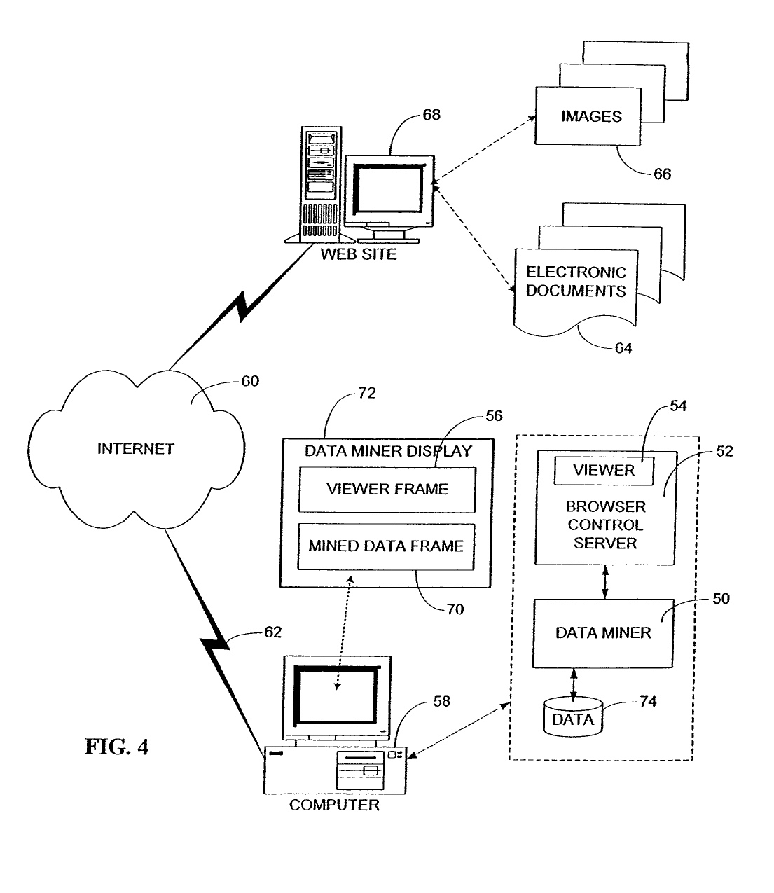

FIG. 3 illustrates a detailed block diagram of a client/server architecture in accordance with a preferred embodiment of the present invention. Although the client application programs 26 and server software 32 are shown as resident in a two computer system, persons skilled in the art will recognize that the present invention may be implemented in a variety of configurations.

While there are a number of different types of client application programs 26, perhaps the most important application for retrieving and viewing information from the Internet is the network browser 36. The network browser 36 is commonly referred to today as a web browser because of its ability to retrieve and display Web pages from the World Wide Web. Some examples of commercially available browsers include Internet Explorer® by Microsoft Corporation of Redmond, Washington, Netscape® Navigator by Netscape Communications of Mountain View, Calif., and Mosaic developed at NCSA, University of Illinois.

Generally speaking, to retrieve information from computers on the Internet, the network browser communicates with the server software using a protocol, such as the File Transfer Protocol (FTP), Simple Mail Transfer Protocol (SMTP), Hyper Text Transfer Protocol (HTTP), Gopher document protocol and others. HTTP is the protocol used to access data on the World Wide Web, and is therefore shown in FIG. 3. The web browser 36 uses HTTP to retrieve documents created in HTML from the server 30, which may be a Web server on the Internet or a server on an intranet. The Web browser 36 can even retrieve documents from the user's own local file system on the hard drive. The location of the resource, such as an HTML document, is defined by an address called a URL (“Uniform Resource Locator”). Of particular importance, the Web browser 36 uses the URL to find and fetch resources from the Internet and the World Wide Web.

HTML allows embedded “links” to point to other data or documents, which may be found on the local computer or other remote Internet host computers. When the user selects an HTML document link, the Web browser can retrieve the document or data that the link refers to by using HTTP, FTP, Gopher, or other Internet application protocols. This feature enables the user to browse linked information by selecting links embedded in an HTML document. A common feature of Web browsers is the ability to save navigation history so that the user can move forward and backward across the Web pages that he or she has already retrieved.

As shown in FIG. 3, server software 32 sends information to the client in the form of HTTP responses 38. The HTTP responses 38 correspond with the Web pages represented utilizing HTML, or other data generated by the server software 32. Server software 32 provides the HTML 40. Under certain browsers, a Common Gateway Interface (CGI) 42 is also provided, which allows the client 26 to direct the server software 32 to commence execution of a specified program contained within the server software 32. This may include a search engine that scans received information in the server for presentation to the user. Utilizing this interface and HTTP responses 38, the server software 32 may notify the client 26 of the results of that execution upon completion. Common Gateway Interface (CGI) 42 is one form of a gateway, a device utilized to connect dissimilar networks (i.e., networks utilizing different communications protocols) so that electronic information can be passed from one network to the other. Gateways transfer electronic information, converting such information to a form compatible with the protocols utilized by the second network for transport and delivery.

In order to control the parameters of the execution of this server-resident process, the client may direct the filling out of certain “forms” from the browser. This is provided by the “fill-in-forms” functionality (i.e., forms 44), which is provided by some browsers. This functionality allows the user via a client application program to specify terms in which the server causes an application program to function (e.g., terms or keywords contained in the types of stories/articles which are of interest to the user). This functionality is an integral part of the search engine.

The present invention provides a data mining application or module, referred to herein as a data miner, that allows a user to retrieve and organize selected information from an electronic document, such as an HTML document, and automatically associate the source or address information with the retrieved information for later reference by the user. The present invention is designed to function in association with or as an integral part of any web browser.

For simplicity, the preferred embodiment of the present invention will be described as a separate application program which functions in combination with Microsoft's Internet Explorer® web browser as described in U.S. Pat. No. 6,101,510, the details of which are incorporated by reference. This particular web browser includes a web browser control that allows application program developers to incorporate web browser functionality into application programs through an application programming interface. This interface is comprised of member functions, events and properties that enable the code of the data miner of the present invention to interact with the Web browser. The browser functions incorporated in the data miner include high level services such as “navigate,” “refresh,” “forward,” and “backward.” The browser control interface events allow the browser control to notify the data miner when certain actions occur and to take a specified action in response to an event. The properties of the interface provide information about the browser control, such as the URL of the page that it is currently processing, whether it is currently busy navigating to a Web page, the title of the Web page, the date the Web page is accessed, etc.

The browser control interface is implemented in a “server” program that is dynamically linked with the data miner at run time. To use the services of the web browser control, the data miner instructs the server to create an instance of a web browser control. The data miner interacts with an instance of the browser control by invoking member functions and receiving notification messages through the browser control's interface for that instance. The web browser control encapsulates the data from browsing operations, including the URL of a Web page, a navigation stack and the HTML content of the page.

The data miner supports the presentation of the Web browser control on the display of the computer by creating a window for an instance of the control. The instance of the control displays its output and interacts with the user through a viewer frame, which it displays in the window created by the data miner.

The level of encapsulation of the web browser is such that the data miner does not need to know any details about how the web browser control provides its web browsing services. For example, the data miner does not need to create or maintain a navigation stack because the Web browser control manages the navigation stack. The Web browser control provides detailed information about navigation to the data miner. Detailed information can be passed to the methods and events in the browser control interface, such as a URL, a target frame name, post data, and HTTP headers. This allows the data miner to control navigation to a Web page and control the presentation of the Web page in the viewer frame of the data miner.

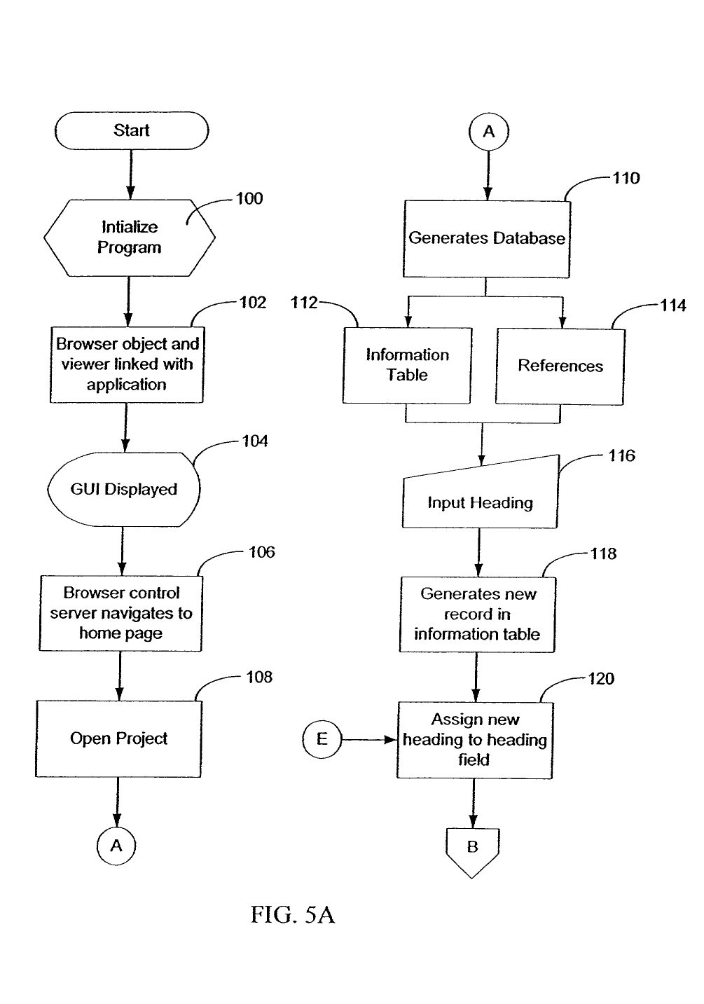

FIG. 4 illustrates an example embodiment of how the data miner uses a browser control to retrieve and display HTML documents. In this implementation, the data miner 50 is dynamically linked with the browser control server program 52 which is implemented as a dynamic link library (DLL). The browser control server program 52 also includes a hypertext viewer 54 which is responsible for parsing and rendering an HTML document into a viewer frame 56 in the computer's display screen. The computer 58 is connected to the Internet 60 via a communications connection 62, such as a telephone line, an ISDN, TI or like high speed phone line, a television cable, a satellite link, an optical fiber link, an Ethernet or other local area network technology wire, radio or optical transmission devices, etc.

Electronic documents 64 and images 66 are stored at remote web sites 68. The data miner 50 uses the functionality provided by the browser control server 52 to retrieve electronic documents 64 of interest and display them in the viewer frame 56. The data miner 50 allows data to be selected in the viewer frame 56 and copied to the mined data frame 70 with the URL or address information automatically associated for later reference by the user. Copying of the mined data can be triggered by any number of well know methods, such as drag-and-drop or copy-and-paste functions or by clicking a button shown in the data miner display 72. In highly preferred embodiments, the mined data is stored in a database 74 under headings selected by the user. The data and headings can be compiled into a report and either printed or exported to a word processor or other application program.

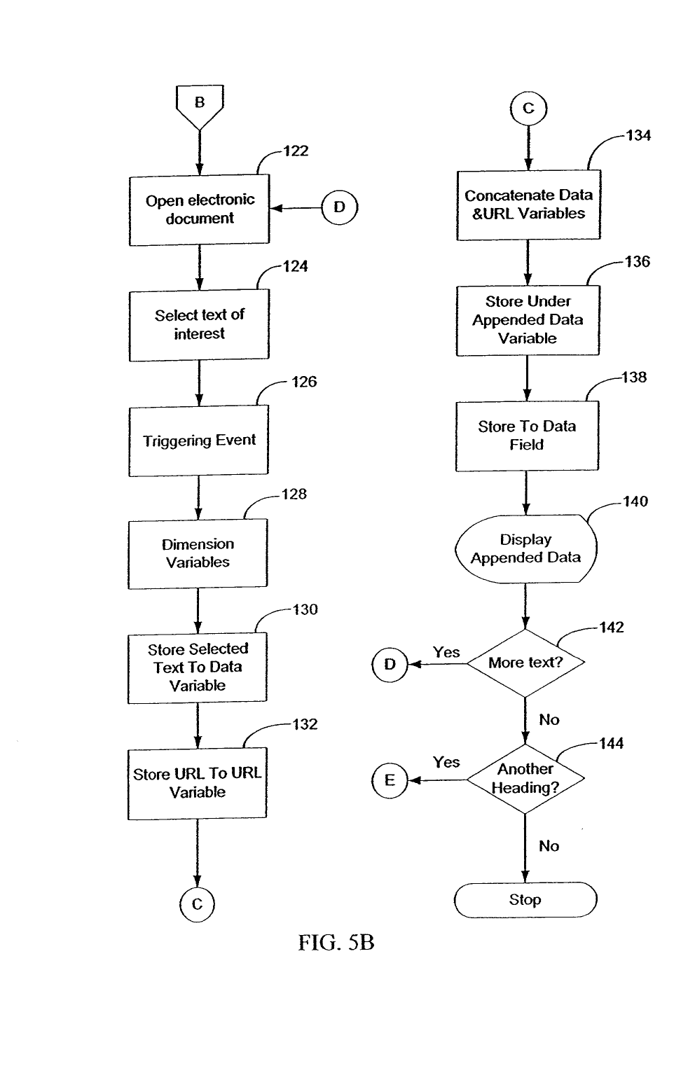

FIGS. 5A and 5B illustrate the process flow of the preferred embodiment of the present invention. To start the process, the user initializes the data miner program (step 100). The browser object and viewer are linked with the data miner (step 102), the graphic user interface is displayed on the monitor (104) and the browser control server navigates to the home page (step 106). To this point, the viewer frame occupies much of the window for the graphic user interface. The user chooses the open project selection from the file menu (step 108) and assigns a name to the research project, prompting the data miner program to generate a database (step 110) which includes an information table (step 112) and references (step 114). Preferably, the user is then prompted by the graphic user interface to input a heading for the current session (step 116) which generates a new record in the information table (step 118) and assigns a new heading to the heading field (step 120).

Using the data miner, the user is able to use the functionality of the web browser to navigate to a selected URL and open an electronic document of interest (step 122). After perusing the electronic document, the user selects text of interest (step 124) and performs the triggering event (step 126), such as a drag-and-drop function. This causes the data miner program to dimension variables (step 128) and then to store the selected text to a data variable (step 130) and the URL or other source address for the electronic document to the URL variable (step 132). Preferably, the data miner automatically concatenates or appends the data variable and the URL variable (step 134) and stores the result under an appended data variable (step 136) which is stored to a data field of the database (step 138). The appended data is displayed in the mined data frame of the graphic user interface. In highly preferred embodiments, the URL appended to the selected text will appear as a hyperlink, allowing the user to link back to the source electronic document.

If the user desires to select more text under the present heading, the user can open another electronic document and repeat the sequence (letter D). Alternatively, the user can assign a new heading to the heading field to repeat the sequence (letter E), which will clear the mined data frame, allowing the user to organize new information under the new heading. The user can cycle through these steps as many times as desired organizing data copied from the viewer frame to the mined data frame while automatically appending the URL for the copied data. When complete, the user can print a compiled report of the headings, mine data and URL's and then save and close the project.

Although in the presently preferred embodiment the process is started by the user initiating the data mining software, persons skilled in the art will recognize that the present invention can be linked to a browser in such a way that the process is started by initiating the browser software. It will also be understood that the data and source information do not necessarily need to be appended or concatenated. Rather, it is sufficient that the data and source information be associated in some manner.

In an alternative embodiment, object oriented practices can be used in which collection routines pull data and citation attributes for the selected data. The data and citation attributes are stored in an instantiated object and associated in that manner.

It will be clear that the present invention is well adapted to attain the ends and advantages mentioned as well as those inherent therein. While presently preferred embodiments have been described for purposes of disclosure, numerous changes may be made which will readily suggest themselves to those skilled in the art and which are encompassed in the spirit of the invention disclosed and as defined in the appended claims.

That which is claimed is:

1. A method of appending a URL address to data copied from an electronic document stored on a global computer network, comprising the steps of:
storing the URL address;
storing the selected data; and
concatenating the URL address to the stored data.

2. A method of organizing data comprising the steps of:
selecting data in an electronic document having a source address;
copying the selected data; and
automatically associated the source address to the selected data.

3. The method of claim 2, wherein step of automatically associating the source address to the selected data further comprises appending the source address to the selected data at the destination.

4. The method of claim 2, wherein the step of automatically associating the source address to the selected data further comprises storing data and citation attributes in an instantiated object.

5. A method of organizing data comprising the steps of:
selecting desired data from an electronic document stored on a computer network;
collecting data and citation attributes for the selected data; and
automatically associating the data and citation attributes.

6. The method of claim 5 wherein the data and citation attributes are automatically associated by storing them in an instantiated object.
